(19) United States
(12) Patent Application Publication
(10) Pub. No.: US 2013/0275702 A1
(43) Pub. Date: Oct. 17, 2013

(54) SEMICONDUCTOR MEMORY DEVICE AND METHOD FOR READING OUT DATA

(71) Applicant: LAPIS SEMICONDUCTOR CO., LTD., Kanagawa (JP)

(72) Inventors: Satoshi MIYAZAKI, Kanagawa (JP); Hiroyuki FUKUYAMA, Kanagawa (JP)

(73) Assignee: LAPIS SEMICONDUCTOR CO., LTD., Kanagawa (JP)

(21) Appl. No.: 13/862,369

(22) Filed: Apr. 12, 2013

(30) Foreign Application Priority Data
Apr. 13, 2012 (JP) 2012-091526

(51) Int. Cl. G06F 12/14

(52) U.S. Cl. CPC G06F 12/1416
USPC 711/163

(57) ABSTRACT

Unique output control is carried out in allowing or prohibiting an output unit to deliver data to outside from a memory unit, when the data at a designated address is read out of the memory unit in response to an address signal designating that address. The memory unit has an output enable/disable flag stored at a predetermined address. This flag is indicative of whether to permit the data to be delivered to outside. After power is turned on, the output unit prohibits the delivery of the data to outside until the output enable/disable flag indicates permission for data delivery to outside and the address signal designating the predetermined address is continuously supplied over N times the clock period of a clock signal. N is an integer equal to or greater than two.

### BACKGROUND OF THE INVENTION

1. Field of the Invention

The present invention relates to semiconductor memory devices, and more particularly to a semiconductor memory device that stores data carrying security information. The present invention also relates to a method of reading data from such semiconductor memory device.

2. Description of the Related Art

Integrated circuit (IC) cards can exchange information by sending or receiving electrical signals to or from remote devices such as terminal devices through external terminals of the IC card. Some IC cards are used in a system, which requires security, such as for credit payments or banking. The IC card used in such system is provided with memory for storing security information such as the personal information of the card owner (holder), credit card number, or the history of account settlements. Therefore, a certain type of semiconductor integrated device is often used as an IC card if the semiconductor integrated device possesses a function for preventing unauthorized access to the IC card in order to hinder unexpected reading of the security information. One example of this type of semiconductor integrated device is shown in FIG. 1 in Japanese Patent Application Publication (Kokai) No. 08-292915. This semiconductor integrated device is provided with a readout prohibiting control circuit. This readout prohibiting control circuit is configured such that once a signal for prohibiting the data from being read to outside from the memory in which the security information is stored is entered, an access to the memory from outside for reading of the data is never permitted.

However, the readout prohibiting control circuit may malfunction, which is deliberately caused by altering a clock frequency or the like. This would allow the stored contents to be estimated on the basis of erroneous output results. This is called a fault analysis attack. When the fault analysis attack was utilized, there was a possibility of leakage of the security information.

### SUMMARY OF THE INVENTION

One object of the present invention is to provide a semiconductor memory device that is highly resistant to attack for reading the stored data in an unauthorized manner.

Another object of the present invention is to provide a readout method for a semiconductor memory device that is highly resistant to attack that attempts to read the stored data in an unauthorized manner.

According to one aspect of the present invention, there is provided a semiconductor memory device that includes a memory unit for reading data stored at an address in response to an address signal indicative of the address. The semiconductor memory device also includes an output unit for delivering the data read out of the memory unit to outside. An output enable/disable flag indicative of whether to permit delivery of the data to outside is stored at a particular address (predetermined address) in the memory unit. The output unit prohibits the delivery of the data to outside after power is turned on until the output enable/disable flag indicates permission for the data delivery to outside and the address signal indicative of the predetermined address is continually supplied over a certain period of time (i.e., N times the clock period of a clock signal). N is an integer equal to or greater than two.

According to another aspect of the present invention, there is provided a method for readout of data from a semiconductor memory device. The memory device includes a memory unit for reading data stored at an address in response to an address signal indicative of the address, and an output unit for delivering the data read out of the memory unit to outside. The data readout method includes storing an output enable/disable flag indicative of whether to permit the delivery of the data to outside, at a particular address (predetermined address) in the memory unit. The data readout method also includes reading the output enable/disable flag in response to the address signal indicative of the predetermined address. The data readout method also includes determining whether the output enable/disable flag is indicative of permission for the data delivery to outside. The data readout method also includes determining whether the address signal indicative of the predetermined address is continuously supplied for a duration of N times the clock period of a clock signal after power is turned on. N is an integer equal to or greater than two. The data readout method also includes prohibiting the output unit from delivering the data to outside until it is determined that the output enable/disable flag is indicative of permission for the data delivery to outside and also determined that the address signal indicative of the predetermined address has been continuously supplied over N times the clock period.

The semiconductor memory device according to the present invention prohibits delivery of data to outside from the memory unit after power has been turned on until the output enable/disable flag stored in the memory unit indicates permission for the data delivery to outside and an address signal indicative of the address of this output enable/disable flag (referred to as “particular address” or “predetermined address” in an exemplary embodiment of the invention) is continuously supplied over N times the clock period of the clock signal. N is an integer equal to or greater than two.

During the testing of the product (semiconductor memory device, or an apparatus having the semiconductor memory device) before shipment, a value indicative of permission for data delivery to outside is stored as the output enable/disable flag, thereby enabling the data read out of the memory unit to be delivered to outside. At the time of shipment of the product, on the other hand, a value indicative of prohibition of data delivery to outside is stored as the output enable/disable flag, thereby prohibiting the delivery of the data to outside. This can prevent leakage of the data stored in the memory device.

It is also possible to provide high resistance to an attack which may cause malfunctioning of the semiconductor memory device after shipment. The attach supplies to the semiconductor memory device a clock signal having a frequency higher than a recommended frequency. The resulting malfunctioning would cause the reading of a value different from the value stored at the predetermined address. This value permits the delivery of data to outside so that the stored data would be delivered to outside in an unauthorized manner. The present invention can prevent such malfunctioning and unauthorized delivery of data to outside.

These and other objects, aspects and advantages of the present invention will become apparent to those skilled in the art from the following detailed description and claims when read and understood in conjunction with the accompanying drawings and claims.

### BRIEF DESCRIPTION OF THE DRAWINGS

FIG. 1 is a block diagram of a semiconductor chip having a semiconductor memory device according to an embodiment of the present invention;

FIG. 2 is a block diagram illustrating the internal configuration of an output determination unit and a particular-address determination unit in the semiconductor chip shown in FIG. 1;

FIG. 3 illustrates a system configuration for testing the semiconductor chip shown in FIG. 1 with a tester;

FIG. 4 is a time chart showing a testing operation performed by the tester of FIG. 3, together with behaviors of the semiconductor chip during the testing;

FIG. 5A illustrates a time chart for the readout operation of the memory unit of the semiconductor chip shown in FIG. 1 when a clock signal is supplied at a recommended frequency; and

FIG. 5B illustrates a time chart for the readout operation of the memory unit when a clock signal is supplied at a frequency higher than the recommended frequency (at a frequency of fault analysis attack).

### DETAILED DESCRIPTION OF THE INVENTION

In the present invention, output control is performed on a memory unit 102 that is adapted to read data stored at an address in response to an address signal A₀₋₇ indicative of that address. Specifically, the output control is performed when allowing an output unit 104, 105 to deliver data to outside from the memory unit 102. The memory unit 102 has an output enable/disable flag stored at a particular address. This flag is configured to be indicative of whether to permit data to be delivered to outside. After power has been turned on, the output unit prohibits the delivery of the data to outside until the output enable/disable flag indicates permission for data delivery to outside and the address signal indicative of the particular address is continually supplied for N times the clock period of a clock signal CLK. N is an integer equal to or greater than two.

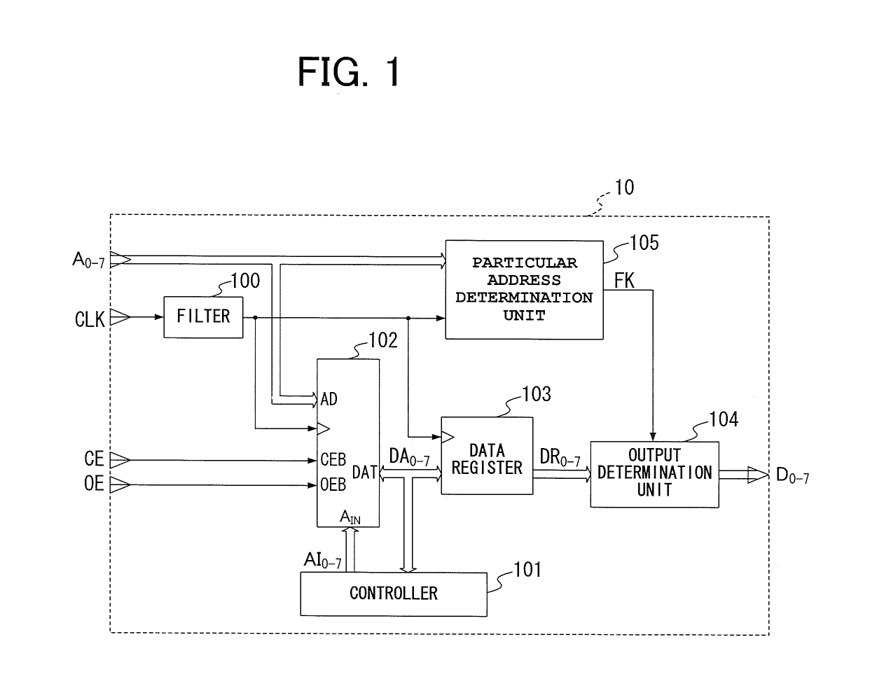

Referring to FIG. 1, a schematic configuration of a semiconductor chip 10 is described. A semiconductor memory device of the invention is provided in the semiconductor chip 10.

As shown in FIG. 1, the semiconductor chip 10 includes a filter 100, a controller 101, a memory unit 102, a data register 103, an output determination unit 104, and a particular-address determination unit 105.

The filter 100 removes a clock pulse, that is, a high frequency component equal to or greater than a threshold frequency above which each of the above-mentioned modules are disabled, from a clock signal CLK supplied through an external terminal of the semiconductor chip 10. The filter 100 then supplies the resulting clock signal having no clock pulse to the memory unit 102, the data register 103, and the particular-address determination unit 105. It should be noted that the memory unit 102, the data register 103, and the particular-address determination unit 105 would be brought into a disabled state when the clock signal CLK having a frequency higher than the threshold frequency were supplied.

The memory unit 102 is, for example, a 256-byte nonvolatile flash memory device, and is configured to store various security data. The memory unit 102 has addresses from [0x00] to [0xFF] in this embodiment, and the security data is stored at addresses between [0x01] and [0xFF] in the memory unit 102. The memory unit 102 stores, at the address [0x00] therein, an output enable/disable flag that indicates whether or not to permit the data having been read out of the memory unit 102 to be delivered to outside. For example, a value 0xFF is stored at the address [0x00] to permit the data to be delivered to outside, whereas a value other than 0xFF is stored at the address [0x00] to prevent the data from being delivered to outside. Immediately after the semiconductor chip 10 is manufactured, 0xFF is stored as an initial value in the whole region of the memory unit 102, i.e., the value 0xFF is stored at the addresses [0x00] to [0xFF]. Therefore, at this point in time, the value 0xFF indicating permission of data delivery to outside is stored at the address [0x00] in the memory unit 102. In this embodiment, the address [0x00] at which the output enable/disable flag is stored is referred to as the particular address.

The memory unit 102 reads the stored data as 8-bit data signal DA₀₋₇ in response to the clock signal CLK, a chip enable signal CE, an output enable signal OE, and external address signal A₀₋₇, which are supplied through the respective external terminals of the semiconductor chip 10. The clock period of the clock signal CLK is the period of access for one address to the memory unit 102. Thus, the memory unit 102 reads the data stored at a designated address as the data signal DA₀₋₇ in response to the external address signal A₀₋₇ designating that addresses in synchronization with the clock signal CLK, and then supplies the data signal DA₀₋₇ to the controller 101 and the data register 103. It should be noted that when the memory unit 102 is supplied with the internal address signal AI₀₋₇ from the controller 101, the memory unit 102 reads the data stored at the address designated by the internal address signal AI₀₋₇ as the data signal DA₀₋₇, and then supplies the data signal DA₀₋₇ to the controller 101 and the data register 103.

To perform various types of processing (not described) using the data stored in the memory unit 102, the controller 101 receives the data signal DA₀₋₇ indicative of the data read out of the memory unit 102 while supplying the internal address signal AI₀₋₇ to the memory unit 102.

The data register 103 receives the data signal DA₀₋₇ read out of the memory unit 102 in response to the clock signal CLK and then supplies the data signal DA₀₋₇ to the output determination unit 104 as readout data signal DR₀₋₇.

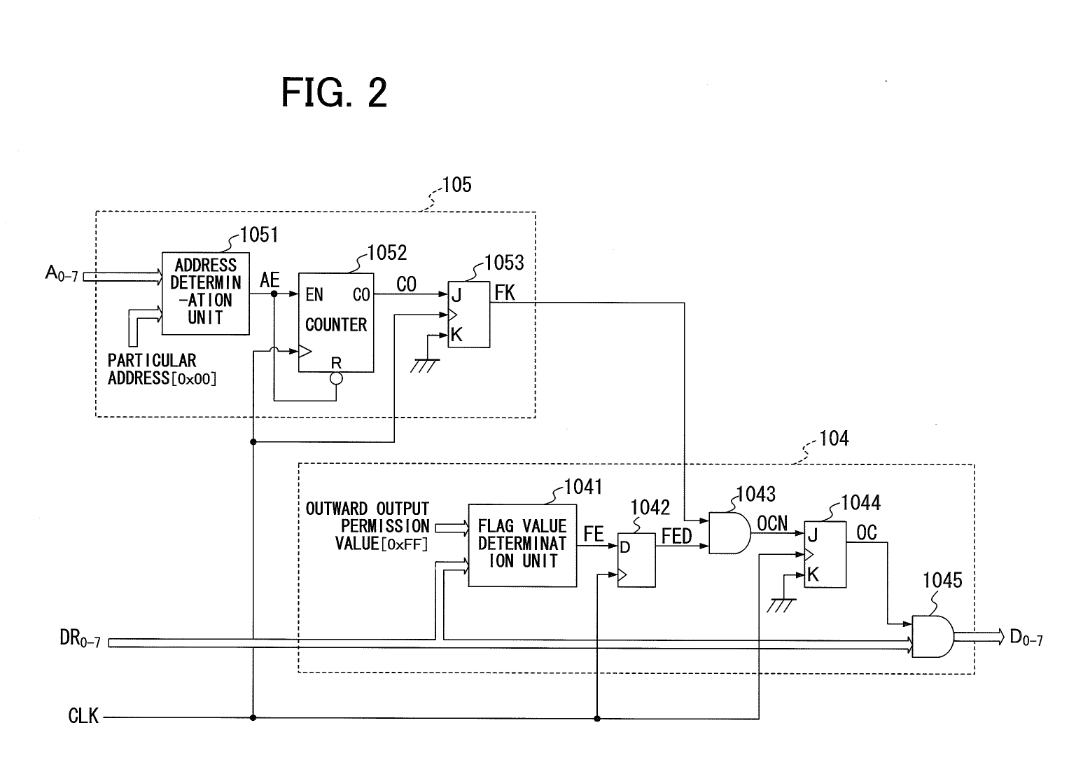

Referring to FIG. 2, the internal configuration of the output determination unit 104 and the particular-address determination unit 105 is described.

As shown in FIG. 2, the predetermined-address determination unit 105 includes an address determination circuit 1051, a counter 1052, and a JK flip-flop circuit (referred to as the JK-FF) 1053. The address determination circuit 1051 determines whether the address designated by the external address signal A₀₋₇ designates the above-mentioned predetermined address [0x00]. The address determination circuit 1051 generates a particular-address coincidence signal AE and then supplies the resulting signal AE to the counter 1052. The particular-address coincidence signal AE is at logic level 1 when the external address signal A₀₋₇ is indicative of the particular address [0x00] and at logic level 0 when the external address signal A₀₋₇ is indicative of an address other than the particular address [0x00]. The counter 1052 counts the number of clock pulses of the clock signal CLK only while the particular-address coincidence signal AE is being supplied at logic level 1, and supplies, to the terminal J of the JK-FF 1053, a carry-out signal CO which transitions from logic level 0 to logic level 1 when the count value has reached “128.” The counter 1052 is maintained in a reset condition while the particular-address coincidence signal AE at logic level 0 is being supplied, and the count value thereof is fixed to the initial value. At the initial state when power is turned ON, the JK-FF 1053 supplies, to the output determination unit 104, a particular-address confirmation signal FK at logic level 0 which is indicative of not being the particular address. While the carry-out signal CO is at logic level 0 after power is turned on, the JK-FF 1053 continues to supply the particular-address confirmation signal FK at logic level 0 to the output determination unit 104. When the carry-out signal CO at logic level 1 is supplied from the counter 1052 to the terminal J, the JK-FF 1053 supplies, to the output determination unit 104, the particular-address confirmation signal FK at logic level 1 indicative of being the particular address.

If the address indicated by the external address signal A₀₋₇ is the particular address [0x00] and this state continues for 128 times the clock period of the clock signal CLK, then the particular-address determination unit 105 starts and continues to supply the particular-address confirmation signal FK at logic level 1 to the output determination unit 104. That is, when the external address signal A₀₋₇ indicates an address other than the particular address [0x00] or the state indicative of the particular address [0x00] continues only for a period of time shorter than 128 times the clock period, the particular-address determination unit 105 supplies the particular-address confirmation signal FK at logic level 0 to the output determination unit 104.

As shown in FIG. 2, the output determination unit 104 includes a flag value determination circuit 1041, a D flip-flop circuit (referred to as the D-FF) 1042, an AND gate 1043, and a JK-FF 1044.

The flag value determination circuit 1041 compares the value indicated by the readout data signal DR₀₋₇ supplied from the data register 103 with an external delivery permission value 0xFF indicative of permission of delivering the readout data to outside. When the value of the signal DR₀₋₇ coincides with the value 0xFF, the circuit 1041 generates the output enable/disable flag coincidence signal FE at logic level 1. If these values do not coincide with each other, the circuit 1041 generates the signal FE at logic level 0. The circuit 401 then supplies the resulting signal to the D-FF 1042. The D-FF 1042 receives the output enable/disable flag coincidence signal FE in response to the clock signal CLK. The D-FF 104 then generates an output enable/disable flag coincidence signal FED, and supplies the resulting signal FED to the AND gate 1043. If the output enable/disable flag coincidence signal FED and the particular-address confirmation signal FK are both at logic level 1, then the AND gate 1043 generates an output control signal OCN at logic level 1 to deliver the readout data to outside, and otherwise generates the output control signal OCN at logic level 0 to prohibit the data delivery to outside. The AND gate 1043 supplies the output control signal OCN to the terminal J of the JK-FF 1044. When power is turned ON, the JK-FF 1044 supplies, to an AND gate 1045, an output control signal OC at logic level 0 to prohibit the delivery of the data to outside. While the output control signal OCN is at logic level 0 after power is turned on, the JK-FF 1044 continues to supply the output control signal OC at logic level 0 to the AND gate 1045. If the output control signal OCN at logic level 1 is supplied from the AND gate 1043, the JK-FF 1044 continues to supply, to the AND gate 1045, the output control signal OC at logic level 1 to deliver the data to outside. While the output control signal OC at logic level 0 is being supplied, the AND gate 1045 generates, through the external terminal of the semiconductor chip 10, an 8-bit data signal D₀₋₇ with all the bits at logic level 0. On the other hand, while the output control signal OC at logic level 1 is being supplied, the AND gate 1045 uses the data signal DR₀₋₇ supplied from the data register 103 as a data signal D₀₋₇ with no change being made thereto, and then outputs the resulting signal D₀₋₇ through the external terminal of the semiconductor chip 10.

From turning on of power until the particular-address confirmation signal FK at logic level 1 is supplied from the particular-address determination unit 105 and the value of the data signal DR₀₋₇ having been read out of the memory unit 102 takes the value 0xFF indicative of permission to deliver the data to outside, the output determination unit 104 prohibits delivery of the data signal DR₀₋₇ to outside. That is, during that period of time, irrespective of the value of the data signal DR₀₋₇ having been read out of the memory unit 102, the output determination unit 104 outputs, through the external terminal of the semiconductor chip 10, the 8-bit data signal D₀₋₇ with all the bits at logic level 0. After the particular-address confirmation signal FK at logic level 1 is supplied and the data signal DR₀₋₇ having been readout of the memory unit 102 takes the value 0xFF, the data signal DR₀₋₇ is delivered to outside.

After the semiconductor chip 10 has been manufactured and before the shipment of the semiconductor chip 10, security data is written into the memory unit 102. Specifically, the security data is written and stored at the addresses [0x01] to [0xFF] in the memory unit 102 other than the particular address [0x00].

After the security data is stored, a readout test is carried out on the semiconductor chip 10 in order to check if the security data has been successfully written to the memory unit 102.

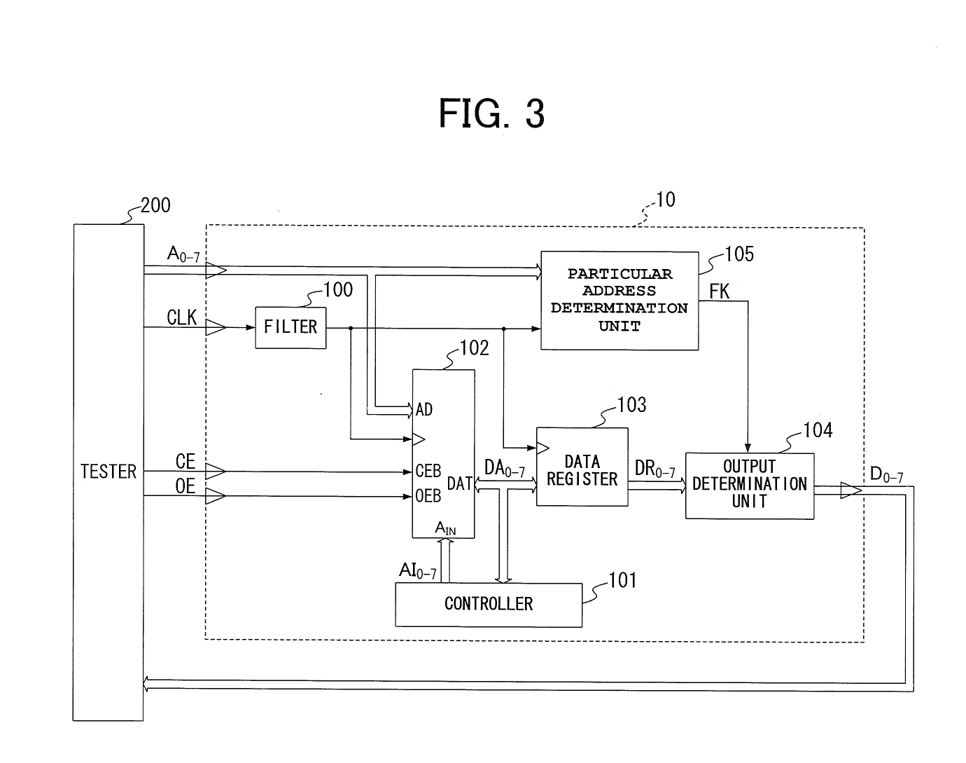

FIG. 3 illustrates a system configuration for carrying out such readout test.

As shown in FIG. 3, the external terminals of the semiconductor chip 10 are connected with a tester 200.

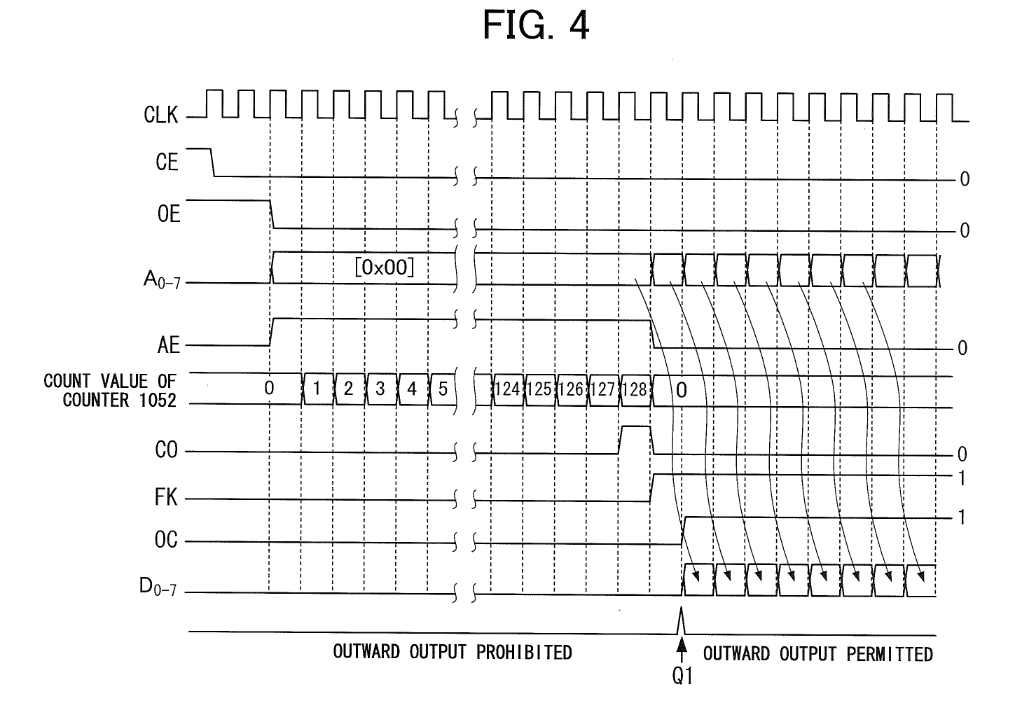

FIG. 4 is a time chart showing the testing operation performed by the tester 200 and the internal operation of the semiconductor chip 10 during the test.

First, the tester 200 supplies, to the semiconductor chip 10, the clock signal CLK such as the one shown in FIG. 4 and the chip enable signal CE at logic level 0 to activate the semiconductor chip 10. Subsequently, the tester 200 supplies, to the semiconductor chip 10, the output enable signal OE at logic level 0 to read data out of the memory unit 102.

The tester 200 performs the setting so as to allow the data read out of the memory unit 102 to be delivered to outside. Specifically, as shown in FIG. 4, the tester 200 supplies the external address signal A₀₋₇ designating the particular address [0x00] to the semiconductor chip 10 for 128 times the clock period of the clock signal CLK. This causes the counter 1052 of the particular-address determination unit 105 to start counting. The counting starts upon supplying of the external address signal A₀₋₇ indicative of the particular address [0x00]. Since the particular-address confirmation signal FK is maintained at logic level 0 while the count value of the counter 1052 is equal to or less than “127,” the output control signal OC at logic level 0 for prohibiting the delivery of the data to outside is supplied to the AND gate 1045. During this period of time, therefore, the 8-bit data signal D₀₋₇ with all the bits at logic level 0 is delivered to outside, irrespective of the value of the data signal DR₀₋₇ read out of the memory unit 102. However, as shown in FIG. 4, when the count value of the counter 1052 reaches “128, ” the particular-address confirmation signal FK transitions from logic level 0 to logic level 1. The value of the data signal DR₀₋₇ read out of the memory unit 102 by designating the particular address [0x00] is the value 0xFF which is indicative of permission of data delivery to outside. At the time Q1 in FIG. 4, the output control signal OC transitions from a state at logic level 0 for prohibiting the delivery of the data to outside to a state at logic level 1 for permitting the delivery of the data to outside. This allows the AND gate 1045 of the output determination unit 104 to deliver to outside, as the data signal D₀₋₇, the data signal DR₀₋₇ with no changes made thereto. From the time Q1 shown in FIG. 4, therefore, it is possible to deliver the data read out of the memory unit 102 to outside.

From the time Q1 in FIG. 4, the tester 200 supplies the external address signal A₀₋₇ indicative of a different address for each clock pulse of the clock signal CLK in order to sequentially read the data from the memory unit 102. The semiconductor chip 10 delivers the data read out of the memory unit 102 to outside as the data signal D₀₋₇. The tester 200 receives the data signal D₀₋₇ issued from the semiconductor chip 10 and determines whether or not the data signal D₀₋₇ agrees with an expected value. This determination is the testing whether the security data has been successfully written to the memory unit 102.

If the test shows that the security data has been successfully written to the memory unit 102, the value stored at the particular address [0x00] of the memory unit 102 is changed to a value to deny permission of data delivery to outside, i.e., a value other than 0xFF. This disables the security data stored in the memory unit 102 to be delivered to outside. The semiconductor chip 10 is shipped in this condition.

Therefore, according to the semiconductor chip 10 shown in FIG. 1, a value indicative of permission for data delivery to outside is stored as the output enable/disable flag during the testing of the product before shipment, and this enables the data read out of the memory unit 102 to be delivered to outside. That is, the security data read out of the memory unit 102 is delivered as the data signal D₀₋₇ from the semiconductor chip 10 to outside, thereby allowing the tester 200 to check if the security data has been successfully stored in the memory unit 102. On the other hand, at the time of shipment of the product, a value to deny permission for the data delivery to outside is stored as the output enable/disable flag, thereby prohibiting the delivery of the data to outside. This can prevent leakage of the security data from the memory unit 102.

According to the above-described embodiment, it is possible to provide the memory unit 102 with high resistance against an attack which may deliberately cause a malfunction in the semiconductor chip 10 after shipment by supplying thereto an unauthorized clock signal CLK having a frequency higher than a recommended frequency. Such attach would otherwise allow the data stored in the memory unit 102 to be delivered to outside in an unauthorized manner.

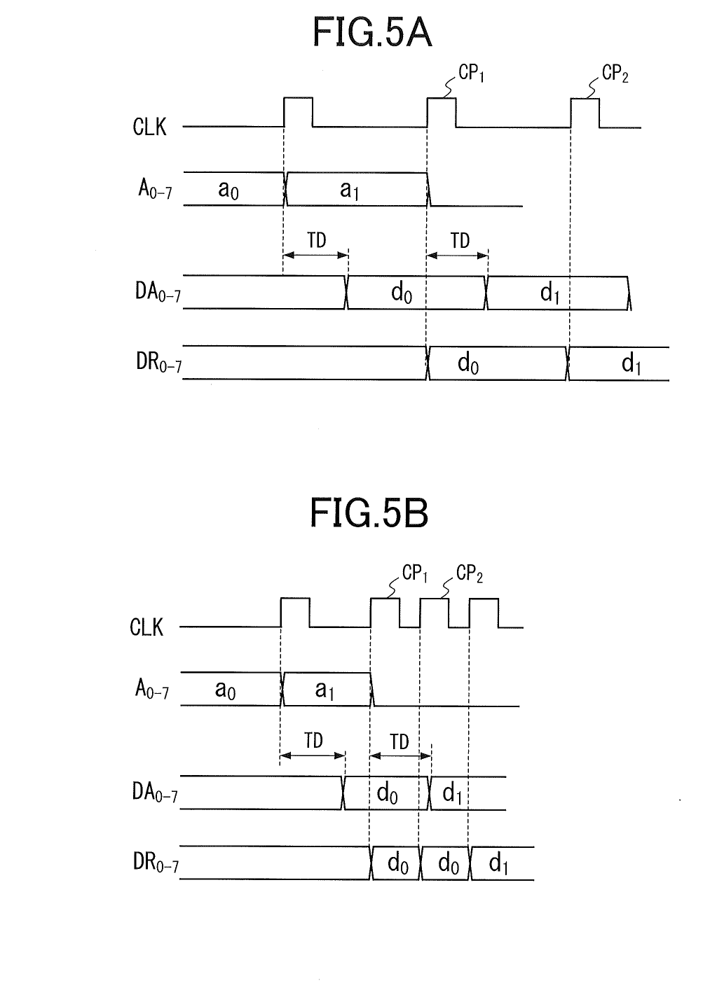

Referring to FIGS. 5A and 5B, this feature of this embodiment is described using a specific example. When the clock signal CLK at the recommended frequency is supplied to the semiconductor chip 10 so as to read data from the memory unit 102, as shown in FIG. 5A, an address al indicated by the external address signal A₀₋₇ is received by the memory unit 102 at the rising edge of a clock pulse CP₁ of the clock signal CLK. The memory unit 102 reads data d1 stored at the address al in response to the clock pulse CP₁. In practice, however, as shown in FIG. 5A, the memory unit 102 sends the data signal DA₀₋₇ indicative of the data d1 at a timing delayed due to a delay TD in the internal operation. The delay TD is a delay from the rising edge of the clock pulse CP₁. Thus, the data register 103 receives the data signal DA₀₋₇ indicative of the data d1 at the rising edge of a clock pulse CP₂ next to the clock pulse CP₂ and supplies it as the readout data signal DR₀₋₇ to the output determination unit 104.

With the clock signal CLK at the recommended frequency, therefore, the data stored at the address al designated at the timing of the clock pulse CP₁ is received by the data register 103 at the timing of the next clock pulse CP₂, and this data is supplied as the readout data signal DR₀₋₇ to the output determination unit 104.

When the frequency of the clock signal CLK is changed to a higher frequency as shown in FIG. 5B, the memory unit 102 sends the data signal DA₀₋₇ indicative of the data d1 at the timing delayed by the delay TD as compared with the rising edge of the clock pulse CP₁, but the next clock pulse CP₂ is supplied during this delay TD. Therefore, at the rising edge of the clock pulse CP₂, the data register 103 receives data d0 which was sent by the memory unit 102 immediately before the rising edge of the clock pulse CP₂, and supplies the received data as the readout data signal DR₀₋₇ to the output determination unit 104.

When the frequency of the clock signal CLK is changed to a higher frequency as shown in FIG. 5B, the data register 103 does not receive, at the timing of the clock pulse CP₂, the data d1 stored at the address a1 but receives the data d0 which is read out of the memory unit 102 immediately before the data d1. Then, the data d0 is supplied as the readout data signal DR₀₋₇ to the output determination unit 104. Accordingly, when there is an access to the memory unit 102 to read data stored at the address a1, data d2 is read which is different from the data d1 stored at the address a1.

When there is an unauthorized access such as the one shown in FIG. 5B, there is a possibility that a value for permitting data delivery to outside is read, even when the value stored at the particular address [0x00] in the memory unit 102 is rewritten at the time of shipment of the product to a value for prohibiting data delivery to outside.

The present invention avoids such possibility. Specifically, the configuration shown in FIGS. 1 and 2 can avoid the above-described unexpected (unauthorized) data delivery to outside. Even when the value for permitting data delivery to outside is read out of the memory unit 102 as the value of the output enable/disable flag, the delivery of the data to outside is prohibited so long as the particular address [0x00] is not designated by the external address signal A₀₋₇ continually over the predetermined period (i.e., 128 times the clock period of the clock signal CLK in this embodiment). That is, even when the frequency of the clock signal CLK is altered to a higher frequency as shown in FIG. 5B, the counter 1052 will never send the carry-out signal CO at logic level 1 so long as the particular address [0x00] is not designated by the external address signal A₀₋₇ continually for 128 times the clock period. Therefore, during the above-mentioned predetermined period (128 times the clock period), both the particular-address confirmation signal FK and the output control signal OC are fixed at logic level 0, and this causes the AND gate 1045 to prohibit the data delivery to outside.

After the particular address [0x00] has been designated by the external address signal A₀₋₇ continuously over 128 times the clock period, the data DA₀₋₇ read out of the memory unit 102 is in a stable state upon an elapse of the time delay TD as shown in FIG. 5A or FIG. 5B. Therefore, the data register 103 eventually receives the data DA₀₋₇ in the stable state and then supplies the data DA₀₋₇ to the output determination unit 104. Thus, even when the frequency of the clock signal CLK is higher than the recommended frequency, the value stored at the particular address [0x00], i.e., the value for prohibiting data delivery to outside, is always supplied to the flag value determination unit 1041. This causes the flag value determination unit 1041 to generate the output enable/disable flag coincidence signal FE at logic level 0. Thus, the output control signal OC is fixed at logic level 0, and the AND gate 1045 prohibits the data delivery to outside.

The present invention can prevent leakage of data from the memory unit 102 when data stored in the memory unit 102 is attacked in an attempt to retrieve the data in an unauthorized manner, even if the attach provides the clock signal CLK at a higher frequency than a recommended frequency and intends to cause malfunction.

It should be noted that in the above-described embodiment the memory unit 102 has a total storage capacity of 256 bytes with the data signals having a size of 8 bits, but the invention is not limited thereto.

In the illustrated embodiment, the output enable/disable flag indicative of whether to permit delivery of the data signal DR₀₋₇ to outside is stored at the address [0x00] of the memory unit 102. Alternatively, the output enable/disable flag may be stored at another address in the memory unit 102.

In the above-described embodiment, the value 0xFF is stored as the output enable/disable flag that permits the data to be delivered to outside, but any suitable value other than 0xFF may be employed as a value of the output enable/disable flag for permission of data delivery to outside and the number of bits is not limited to 8 bits.

In the illustrated embodiment, when the external address signal A₀₋₇ indicative of the particular address [0x00] is supplied continuously over the predetermined period (i.e., 128 times the clock period), the output enable/disable flag is read from the memory unit 102. It should be noted that the predetermined period is not limited to 128 times the clock period. For example, when the external address signal A₀₋₇ indicative of the particular address is supplied over N times the clock period (N is an integer equal to or greater than two), the output enable/disable flag may be read out of the memory unit 102. N is equal to or greater than a calculated value which is obtained by dividing the time delay TD by the minimum limit period of the clock signal CLK that allows the memory unit 102 to normally operate. The time delay TD is time from the start of reading data out of the memory unit 102 until the data has a stable value.

The semiconductor memory device according to the present invention is configured to perform unique output control when allowing (or not allowing) the output unit 104, 105 to deliver, to outside, the data which has been read from a designated address in the memory unit 102 in response to the address signal A₀₋₇ designating that address. Specifically, delivery of data to outside is prohibited after power is turned on until the output enable/disable flag stored at the predetermined address in the memory unit is indicates permission for data delivery to outside and the address signal of the predetermined address is continuously supplied over the predetermined period (N times the clock period of the clock signal CLK). N is an integer equal to or greater than two.

In the above-described embodiment, the output enable/disable flag is stored in the memory unit 102, but the present invention is not limited in this regard. For example, the value of the output enable/disable flag may be given by a fixed power supply (not shown) provided inside the semiconductor chip 10.

In the above-described embodiment, only one output enable/disable flag is set for the entire storage region of the memory unit 102, but the present invention is not limited in this regard. For example, the storage region of the memory unit 102 may be divided into a plurality of sub-regions and each of the sub-regions may be provided with a single output enable/disable flag.

The memory unit 102 may be any suitable memory other than the nonvolatile memory cell device. For example, the memory unit 102 may be a write-once fuse cell such as a metal fuse cell or an electric fuse cell.

This application is based on Japanese Patent Application No. 2012-91526 filed on Apr. 13, 2012 and the entire disclosure thereof is incorporated herein by reference.

What is claimed is:

1. A semiconductor memory device comprising:
a memory unit for reading data stored at an address in response to an address signal indicative of the address;
an output unit for delivering the data read out of the memory unit to outside; and
an output enable/disable flag stored at a predetermined address in the memory unit, the flag being indicative of whether to permit delivery of the data to outside,
wherein the output unit prohibits the delivery of the data to outside after power is turned on until the output enable/disable flag indicates permission for data delivery to outside and the address signal indicative of the predetermined address is continuously supplied over N times a clock period of a clock signal, where N is an integer equal to or greater than two.

2. The semiconductor memory device according to claim 1, wherein the output unit includes a predetermined-address determination unit and an output determination unit,
the predetermined-address determination unit counts a number of clock pulses of the clock signal only while an address indicated by the address signal agrees with the predetermined address,
the predetermined-address determination unit produces a predetermined-address confirmation signal when the count value has reached the N,
the output determination unit prohibits the data delivery to outside until the output enable/disable flag indicates permission for the data delivery to outside and the predetermined-address confirmation signal is produced, and
the output determination unit allows the data read out of the memory unit to be delivered to outside after the output enable/disable flag indicates permission for the data delivery to outside and the predetermined-address confirmation signal is produced.

3. The semiconductor memory device according to claim 1, wherein the N has a value equal to or greater than a result obtained by dividing a time delay by a minimum limit period of the clock signal which allows the memory unit to operate in a normal condition, the time delay being a delay occurring when the data is read out of the memory unit.

4. The semiconductor memory device according to claim 1, wherein the memory unit is a nonvolatile memory device, a metal fuse cell, or an electric fuse cell.

5. The semiconductor memory device according to claim 1 further comprising a filter for removing, from the clock signal, a clock pulse having a frequency higher than a predetermined frequency.

6. The semiconductor memory device according to claim 1, wherein the data stored in the memory unit includes security information.

7. A method of reading data from a semiconductor memory device, the semiconductor memory device including a memory unit for reading data stored at an address in response to an address signal indicative of the address, and an output unit for delivering the data read out of the memory unit to outside, the method comprising:
storing an output enable/disable flag indicative of whether to permit the delivery of the data to outside, at a predetermined address in the memory unit;
reading the output enable/disable flag in response to the address signal indicative of the predetermined address;
determining whether the output enable/disable flag is indicative of permission for data delivery to outside;
determining, after power is turned on, whether the address signal indicative of the predetermined address has been continuously supplied over N times a clock period of a clock signal, where N is an integer equal to or greater than two; and
prohibiting the delivery of the data to outside by the output unit until it is determined that the output enable/disable flag is indicative of permission for data delivery to outside and it is determined that the address signal indicative of the predetermined address has been continuously supplied for N times the clock period.

8. The method of reading data according to claim 7 further comprising:
causing the memory unit and the output unit to stop operating when the clock signal has a frequency higher than a predetermined frequency;
calculating a minimum limit period of the clock signal that allows the memory unit to operate in a normal condition;
calculating a time delay occurring when the date is read from the memory unit; and
prohibiting, when the clock signal has a frequency lower than the predetermined frequency, the delivery of the data to outside by the output unit until the address signal indicative of the predetermined address is continuously supplied over a first period, said first period being the clock signal multiplied by a number of clock pulses that is derived from a result obtained by dividing the time delay by the minimum limit period of the clock signal.

9. The method of reading data according to claim 7, wherein the data stored in the memory unit includes security information.

10. The method of reading data according to claim 9 further comprising determining whether or not the security information is appropriately stored in the memory unit prior to said storing an output enable/disable flag at the predetermined address in the memory unit.

11. The method of reading data according to claim 7, wherein the memory unit is a nonvolatile memory device, a metal fuse cell, or an electric fuse cell.

12. A semiconductor device comprising:
a memory unit for reading data stored at an address in response to an address signal designating the address;
an output unit for delivering the data read out of the memory unit to outside;
means for storing an output enable/disable flag indicative of whether to permit the delivery of the data to outside, at a predetermined address in the memory unit;
means for reading the output enable/disable flag in response to the address signal designating the predetermined address;
means for determining whether the output enable/disable flag is indicative of permission for data delivery to outside;
means for determining, after power is turned on, whether the address signal designating the predetermined address has been continuously supplied over N times a clock period of a clock signal, where N is an integer equal to or greater than two; and
means for prohibiting the delivery of the data to outside by the output unit until it is determined that the output enable/disable flag is indicative of permission for data delivery to outside and it is determined that the address signal designating the predetermined address has been continuously supplied for N times the clock period.

13. The semiconductor device according to claim 12 further comprising:
means for causing the memory unit and the output unit to stop operating when the clock signal has a frequency higher than a predetermined frequency;
means for calculating a minimum limit period of the clock signal that allows the memory unit to operate in a normal condition;
means for calculating a time delay occurring when the date is read from the memory unit; and
means for prohibiting, when the clock signal has a frequency lower than the predetermined frequency, the delivery of the data to outside by the output unit until the address signal designating the predetermined address is continuously supplied over a first period, said first period being the clock signal multiplied by a number of clock pulses that is derived from a result obtained by dividing the time delay by the minimum limit period of the clock signal.

14. The semiconductor device according to claim 12, wherein the data stored in the memory unit includes security information.

15. The semiconductor device according to claim 12 further comprising means for determining whether or not the security information is appropriately stored in the memory unit prior to said storing an output enable/disable flag at the predetermined address in the memory unit.

16. The semiconductor device according to claim 12, wherein the memory unit is a nonvolatile memory device, a metal fuse cell, or an electric fuse cell.
